(19) United States
(12) Patent Application Publication
(10) Pub. No.: US 2019/0373307 A1
(43) Pub. Date: Dec. 5, 2019

(54) WINDOW DISPLAYING NAVIGABLE PROGRAM INFORMATION

(71) Applicant: ARRIS Enterprises LLC, Suwanee, GA (US)

(72) Inventors: Chen Ji, Shanghai (CN); Yu'an Chen, Shanghai (CN); Ren Kunming, Shanghai (CN)

(21) Appl. No.: 15/991,679

(22) Filed: May 29, 2018

(51) Int. Cl. H04N 21/431; H04N 21/443; H04N 21/472

(52) U.S. Cl. CPC H04N 21/4316; H04N 21/472; H04N 21/4438

(57) ABSTRACT

Methods, systems and computer readable media described herein may facilitate the generation and presentation of a window displaying navigable program information. Information associated with a plurality of events may be retrieved, and retrieved information associated with a subset of the events may be presented within a displayed window. The displayed window may include one or more user-selectable navigation icons, each navigation icon having a directional component. When a navigation icon is selected, one or more events making up a different subset of events may be identified based upon the directional component associated with the selected navigation icon, and the displayed window may be refreshed to include information associated with the different subset of events.

### TECHNICAL FIELD

This disclosure relates to a window displaying navigable program information.

### BACKGROUND

A customer premise equipment (CPE) device such as a gateway device or set-top box (STB) is typically provided by a multiple-system operator (MSO) to a subscriber so that the subscriber may receive multimedia services offered by the MSO. The CPE device can be used by the subscriber to access a variety of data services, telephony or voice services, and multimedia services, including but not limited to live or linear television, digital video recorder (DVR) content, video-on-demand (VoD) content, over-the-top (OTT) content, and others.

While viewing content or scanning content received over a DVB (digital video broadcasting) system, IPTV (Internet protocol television) system, or other system capable of delivering multimedia content to a viewer, a viewer may be presented with a display of information associated with a current event and a following event. However, the viewer is not presented with the opportunity to interface with the information presented in the display.

In some scenarios, a viewer may want to view information associated with one or more events or programs that are not presented within the display. However, in order to view information associated with events or programs that are not presented within the display, the viewer is forced to tune away from the currently viewed program and to an EPG (electronic program guide) channel. Therefore, it is desirable to improve upon methods and systems for presenting event or program information to a viewer.

### BRIEF DESCRIPTION OF THE DRAWINGS

FIG. 1 is a block diagram illustrating an example network environment operable to facilitate the generation and presentation of a window displaying navigable program information.

FIG. 2 is a block diagram illustrating an example CPE device operable to facilitate the generation and presentation of a window displaying navigable program information.

FIG. 3 is a flowchart illustrating an example process operable to facilitate a transition between displays of program information.

FIG. 4 is a flowchart illustrating an example process operable to facilitate multiple transitions between displays of program information.

FIG. 5 is an illustration of an example event information window having a user-selectable navigation icon with a next directional component.

FIG. 6 is an illustration of an example event information window having a user-selectable navigation icon with a next directional component and a user-selectable navigation icon with a previous directional component.

FIG. 7 is an illustration of an example event information window having a user-selectable navigation icon with a previous directional component.

FIG. 8 is a block diagram of a hardware configuration operable to facilitate the generation and presentation of a window displaying navigable program information.

Like reference numbers and designations in the various drawings indicate like elements.

### DETAILED DESCRIPTION

It is desirable to improve upon methods and systems for providing event information to a user. Methods, systems and computer readable media described herein may facilitate the generation and presentation of a window displaying navigable program information. Information associated with a plurality of events may be retrieved, and retrieved information associated with a subset of the events may be presented within a displayed window. The displayed window may include one or more user-selectable navigation icons, each navigation icon having a directional component. When a navigation icon is selected, one or more events making up a different subset of events may be identified based upon the directional component associated with the selected navigation icon, and the displayed window may be refreshed to include information associated with the different subset of events.

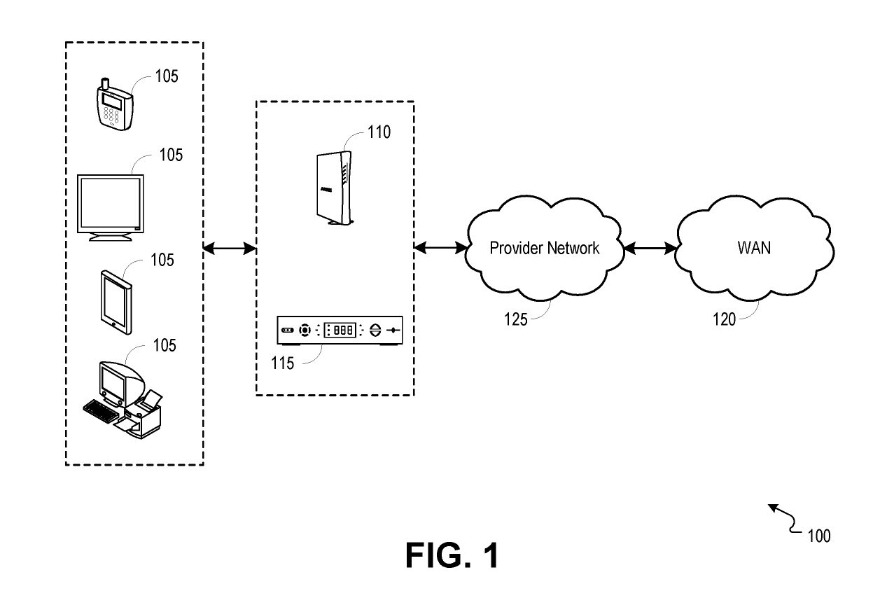

FIG. 1 is a block diagram illustrating an example network environment 100 operable to facilitate the generation and presentation of a window displaying navigable program information. In embodiments, video, voice, and/or data services may be delivered to one or more client devices 105. Client devices 105 may include televisions, mobile devices, tablets, computers, set-top boxes (STB), telephones (e.g., voice over Internet protocol (VoIP) telephones), gaming devices, and any other device operable to receive video, voice, and/or data services. It should be understood that various data, multimedia, and/or voice services may be delivered to the client devices 105, including but not limited to, live or broadcast television, video-on-demand (VoD) content, pay-per view content, recorded content (e.g., DVR content), audio-only content, streaming content, and others.

In embodiments, one or more services delivered to a subscriber premises may be received and forwarded to one or more client devices 105 by a customer premise equipment (CPE) device such as an access device 110 and or STB 115. An access device 110 may include a gateway device (e.g., residential gateway, multimedia gateway, etc.), a router, a wireless network extender, or any other device configured to route communications to and from one or more client devices 105. It should be understood that the devices shown in FIG. 1 may be integrated. For example, a client device 105 such as a television may be connected to a STB 115, an access device 110, and/or may be directly connected to an upstream network.

In embodiments, multiple services (e.g., video, voice, and/or data services) may be delivered from a wide-area network (WAN) 120 to an access device 110 or STB 115 through a connection between the device and a provider network 125. The provider network 125 may include an optical network, hybrid fiber coaxial (HFC) network, digital subscriber line (DSL) network, twisted-pair, mobile network, high-speed data network, MoCA network, and others. Multiple systems operator (MSO) or service provider devices and/or networks within the WAN 120 may be used to provide, manage, and/or troubleshoot the multiple services provided to subscribers. In embodiments, a STB 115 may receive one or more services from an access device 110. For example, network communications/messages, Internet protocol television (IPTV) content or any other streaming content may be streamed from the access device 110 to the STB 115 for output to an associated display device (e.g., television).

In embodiments, multiple services may be delivered from an access device 110 or STB 115 to one or more client devices 105 through a local network. The local network may include a local area network (LAN), wireless local area network (WLAN), personal area network (PAN), Multimedia over Coax Alliance (MoCA) network, mobile hotspot network, and others. The local network may be provided at a subscriber premises by the access device 110 or one or more other access points within the premises. It will be appreciated by those skilled in the relevant art that delivery of the multiple services over the local network may be accomplished using a variety of standards and formats. For example, a CPE device may be configured to deliver media content that is received by the CPE device over a variety of systems (e.g., DVB system, IPTV system, etc.).

In embodiments, a user may control the output of content from a CPE device through a control interface (e.g., one or more controls physically positioned on the CPE device, remote control, etc.). For example, a user may initiate a channel change at a CPE device, and in response, the CPE device may output content from a different source and/or channel.

In embodiments, when a CPE device is tuned to a new channel, or when a new piece of content is otherwise presented to a viewer, the CPE device may generate and display an event information window, wherein the event information window is overlaying a portion of the new content. For example, the event information window may be positioned along an edge (e.g., the bottom edge, top edge, side edge, etc.) of a display window in which the content is presented. The event information may include an identification of one or more events (e.g., programs) that are associated with the content and/or channel that is being presented to a viewer through the CPE device.

In embodiments, the CPE device may retrieve information associated with one or more events. For example, the CPE device may identify a plurality of events, the plurality of events including a current event (i.e., a program currently being presented to a viewer through the CPE device), a following event (i.e., a program that is scheduled to begin following the end of the current event), and one or more scheduled events (i.e., events that are scheduled to begin after the end of the following event). The retrieved information may include information such as event title, event summary, event duration, event start/end time, genre, cast, and other information. The CPE device may include the retrieved information for one or more events in a displayed event information window.

In embodiments, the event information window generated and presented by the CPE device may include a user-selectable navigation icon. For example, the user-selectable navigation icon may be an icon that provides a directional indicator (e.g., an arrow). The directional indicator may indicate a selection of a previous subset of events or a next subset of events. In embodiments, a first event information window presented to a viewer may include a navigation icon that may be selected by a viewer to request a display of information associated with a next subset of events. In embodiments, an event information window presented to a viewer may include a navigation icon that may be selected by a viewer to request a display of information associated with a previous subset of events. In embodiments, an event information window presented to a viewer may include a navigation icon that may be selected by a viewer to request a display of information associated with a next subset of events and a navigation icon that may be selected by a viewer to request a display of information associated with a previous subset of events.

In embodiments, when a CPE device detects a user selection of a navigation icon, the CPE device may determine a subset of events to be included within a refreshed event information window, wherein the determination of the subset of events is based upon the event information currently displayed and a directional component associated with the navigation icon. For example, when the CPE device detects a user selection of a navigation icon that indicates a next subset of events, the CPE device may generate and output for presentation an event information window that includes information associated with one or more events that are scheduled to follow the subset of events currently presented in an event information window. As another example, when the CPE device detects a user selection of a navigation icon that indicates a previous subset of events, the CPE device may generate and output for presentation an event information window that includes information associated with one or more events that are scheduled to precede the subset of events currently presented in an event information window.

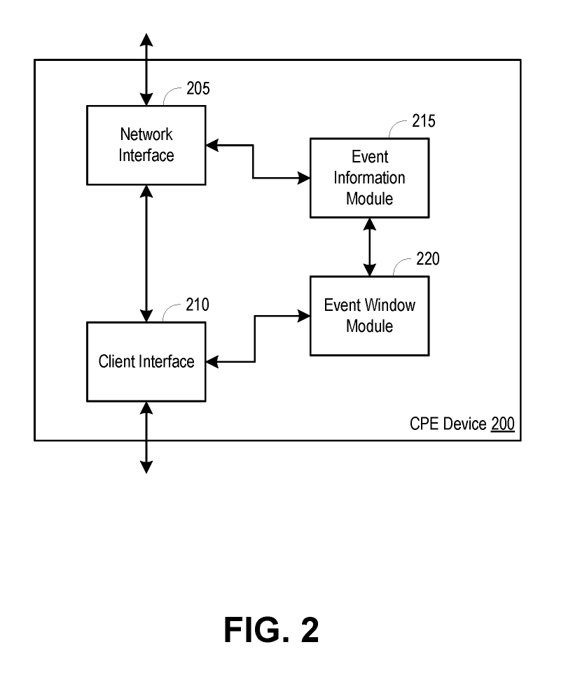

FIG. 2 is a block diagram illustrating an example CPE device 200 operable to facilitate the generation and presentation of a window displaying navigable program information. The CPE device 200 may include a network interface 205, a client interface 210, an event information module 215, and an event window module 220. The CPE device 200 may be an access device 110 of FIG. 1, a STB 115 of FIG. 1, or any other device configured to deliver one or more services to a client device (e.g., client device 105 of FIG. 1).

In embodiments, multiple services (e.g., video, voice, and/or data services) may be received by the CPE device 200 through the network interface 205.

In embodiments, multiple services may be delivered from the CPE device 200 to one or more client devices 105 through the client interface 210. A user may control the output of content from the CPE device 200 through communications received at the client interface 210. For example, a user may initiate a channel change (e.g., through one or more controls physically positioned on the CPE device, remote control, etc.) at the CPE device 200, and in response, the CPE device 200 may output content from a different source and/or channel.

In embodiments, when the CPE device 200 is tuned to a new channel, or when a new piece of content is otherwise presented to a viewer, the event window module 220 may generate and output for display, an event information window, wherein the event information window is overlaying a portion of the new content. For example, the event information window may be positioned along an edge (e.g., the bottom edge, top edge, side edge, etc.) of a display window in which the content is presented. The event information may include an identification of one or more events (e.g., programs) that are associated with the content and/or channel that is being presented to a viewer through the CPE device. For example, the one or more events associated with the content and/or channel may include one or more events that are scheduled for transmission over the channel or that are otherwise scheduled for playback on the channel. The event information window may be output, along with the new content, through the client interface 210.

In embodiments, the event information module 215 may retrieve information associated with one or more events. For example, the event information module 215 may identify a plurality of events, the plurality of events including a current event (i.e., a program currently being presented to a viewer through the CPE device 200), a following event (i.e., a program that is scheduled to begin following the end of the current event), and one or more scheduled events (i.e., events that are scheduled to begin after the end of the following event). The event information may be retrieved from communications or data streams received at the CPE device 200. For example, the event information module 215 may retrieve the event information from received EPG (electronic program guide) data. The retrieved information may include information such as event title, event summary, event duration, event start/end time, genre, cast, and other information. The event information module 215 may provide the event window module 220 with the retrieved information, and the event window module 220 may include the retrieved information for one or more events in a displayed event information window.

In embodiments, the event information window generated and presented by the event window module 220 may include a user-selectable navigation icon. For example, the user-selectable navigation icon may be an icon that provides a directional indicator (e.g., an arrow). The directional indicator may indicate a selection of a previous subset of events or a next subset of events. In embodiments, a first event information window presented to a viewer may include a navigation icon that may be selected by a viewer to request a display of information associated with a next subset of events. In embodiments, an event information window presented to a viewer may include a navigation icon that may be selected by a viewer to request a display of information associated with a previous subset of events. In embodiments, an event information window presented to a viewer may include a navigation icon that may be selected by a viewer to request a display of information associated with a next subset of events and a navigation icon that may be selected by a viewer to request a display of information associated with a previous subset of events.

In embodiments, when the event window module 220 detects a user selection of a navigation icon, the event information module 215 may determine a subset of events to be included within a refreshed event information window, wherein the determination of the subset of events is based upon the event information currently displayed and a directional component associated with the navigation icon. For example, when the event window module 220 detects a user selection of a navigation icon that indicates a next subset of events, the event window module 220 may generate and output for presentation an event information window that includes information associated with one or more events that are scheduled to follow the subset of events currently presented in an event information window. As another example, when the event window module 220 detects a user selection of a navigation icon that indicates a previous subset of events, the event window module 220 may generate and output for presentation an event information window that includes information associated with one or more events that are scheduled to precede the subset of events currently presented in an event information window. A user selection of a navigation icon may be detected by the event window module 220 as a communication received through the client interface 210 (e.g., a communication received through a depressing of a physical button, a communication received from a remote control unit, etc.).

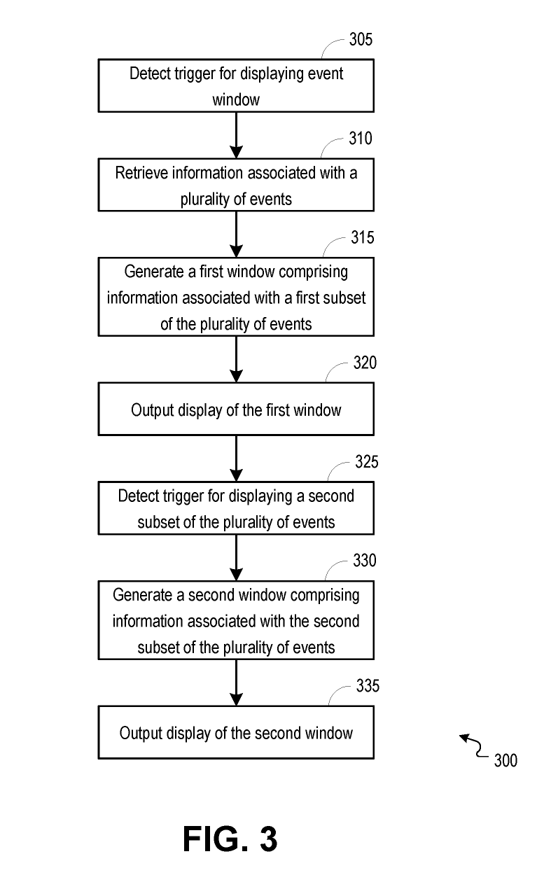

FIG. 3 is a flowchart illustrating an example process 300 operable to facilitate a transition between displays of program information. The process 300 can begin at 305, when a trigger for displaying an event window is detected. The trigger for displaying an event window may be detected, for example, by a CPE device 200 of FIG. 2. In embodiments, the trigger for displaying an event window may be a communication or signal that is received by the CPE device 200 and is designated by the CPE device 200 as a trigger for displaying an event window. For example, a communication or signal designated as a trigger for displaying an event window may include a communication or signal triggering a channel change (e.g., channel up/down, new channel selection, manual input of channel identifier, etc.), a guide/menu request, and others.

At 310, information associated with a plurality of events may be retrieved. The information associated with the plurality of events may be retrieved, for example, by the CPE device 200 (e.g., by an event information module 215 of FIG. 2). In embodiments, the event information module 215 may identify a plurality of events, the plurality of events including a current event (i.e., a program currently being presented to a viewer through the CPE device 200), a following event (i.e., a program that is scheduled to begin following the end of the current event), and one or more scheduled events (i.e., events that are scheduled to begin after the end of the following event). It should be understood that the plurality of events may include programs that are scheduled for transmission over a channel to which the CPE device 200 is currently tuned and/or programs that are otherwise associated with a program currently being presented to a viewer of the CPE device 200 or channel to which the CPE device 200 is currently tuned. The event information module 215 may retrieve information associated with the identified plurality of events, and the event information may be retrieved from communications or data streams received at the CPE device 200. For example, the event information module 215 may retrieve the event information from received EPG (electronic program guide) data. The retrieved information may include information such as event title, event summary, event duration, event start/end time, genre, cast, and/or other information.

At 315, a first window comprising information associated with a first subset of the plurality of events may be generated. The first window comprising information associated with the first subset of the plurality of events may be generated, for example, by the CPE device 200 (e.g., by an event window module 220 of FIG. 2). In embodiments, the event window module 220 may identify a first subset of the plurality of events. For example, the first subset of the plurality of events may include a program currently being presented to a viewer through the CPE device 200 and/or a following event (i.e., a program that is scheduled to begin following the end of the program currently being presented to a viewer through the CPE device 200). The event window module 220 may place retrieved information associated with the first subset of the plurality of events in the first window. The event window module 220 may place a user-selectable navigation icon in the first window. For example, the user-selectable navigation icon may be an icon that provides a directional indicator (e.g., an arrow). The directional indicator may indicate a selection of a next subset of events.

At 320, a display of the first window may be output. For example, the display of the first window may be output from the CPE device 200 to a display associated with the CPE device 200 (e.g., a display or display device connected to or otherwise associated with the CPE device 200).

At 325, a trigger for displaying a second subset of the plurality of events may be detected. The trigger for displaying the second subset of the plurality of events may be detected, for example, by the CPE device 200. In embodiments, the trigger for displaying the second subset of the plurality of events may be a communication or signal that is received by the CPE device 200 and is designated by the CPE device 200 as a trigger for displaying a next subset of events. For example, the trigger for displaying the second subset of the plurality of events may be a communication or signal received by the CPE device 200 in response to a user selection of the user-selectable navigation icon displayed in the first window.

At 330, a second window comprising information associated with a second subset of the plurality of events may be generated. The second window comprising information associated with the second subset of the plurality of events may be generated, for example, by the CPE device 200 (e.g., by an event window module 220 of FIG. 2). In embodiments, the event window module 220 may identify a second subset of the plurality of events. For example, the second subset of the plurality of events may include one or more events that are scheduled to follow the subset of events currently displayed in the first window (i.e., one or more programs that are scheduled to begin following the end of the one or more programs currently identified in the first window). The event window module 220 may place retrieved information associated with the second subset of the plurality of events in the second window. The event window module 220 may place one or more user-selectable navigation icons in the second window. For example, the one or more user-selectable navigation icons may include an icon that provides a next directional indicator (e.g., an arrow) indicating a selection of a next subset of events and/or an icon that provides a previous directional indicator (e.g., an arrow) indicating a selection of a previous subset of events.

At 335, a display of the second window may be output. For example, the display of the second window may be output from the CPE device 200 to a display associated with the CPE device 200 (e.g., a display or display device connected to or otherwise associated with the CPE device 200).

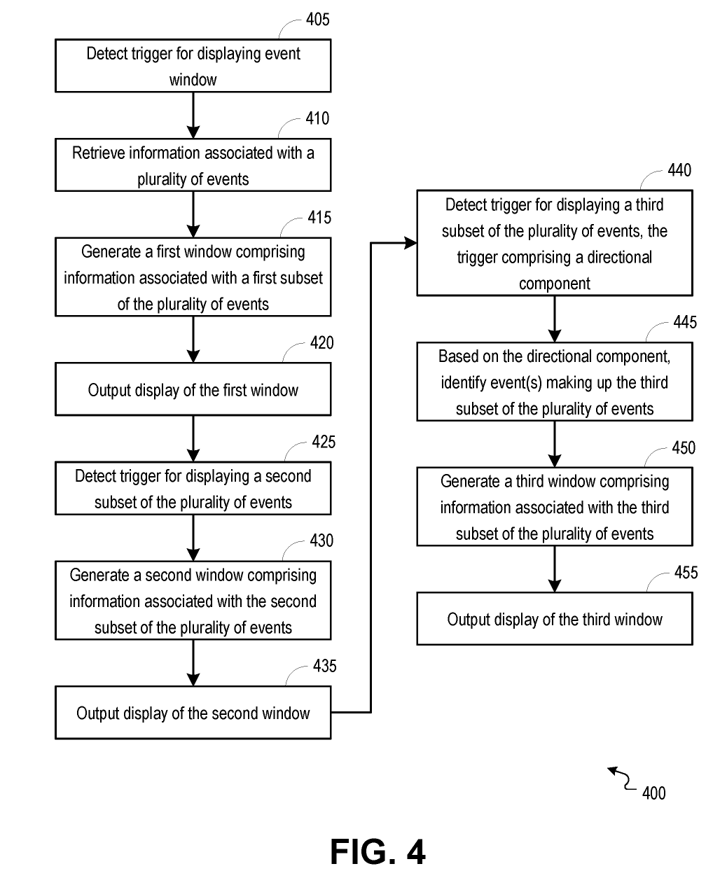

FIG. 4 is a flowchart illustrating an example process 400 operable to facilitate multiple transitions between displays of program information. The process 400 can begin at 405, when a trigger for displaying an event window is detected. The trigger for displaying an event window may be detected, for example, by a CPE device 200 of FIG. 2. In embodiments, the trigger for displaying an event window may be a communication or signal that is received by the CPE device 200 and is designated by the CPE device 200 as a trigger for displaying an event window. For example, a communication or signal designated as a trigger for displaying an event window may include a communication or signal triggering a channel change (e.g., channel up/down, new channel selection, manual input of channel identifier, etc.), a guide/menu request, and others.

At 410, information associated with a plurality of events may be retrieved. The information associated with the plurality of events may be retrieved, for example, by the CPE device 200 (e.g., by an event information module 215 of FIG. 2). In embodiments, the event information module 215 may identify a plurality of events, the plurality of events including a current event (i.e., a program currently being presented to a viewer through the CPE device 200), a following event (i.e., a program that is scheduled to begin following the end of the current event), and one or more scheduled events (i.e., events that are scheduled to begin after the end of the following event). It should be understood that the plurality of events may include programs that are scheduled for transmission over a channel to which the CPE device 200 is currently tuned and/or programs that are otherwise associated with a program currently being presented to a viewer of the CPE device 200 or channel to which the CPE device 200 is currently tuned. The event information module 215 may retrieve information associated with the identified plurality of events, and the event information may be retrieved from communications or data streams received at the CPE device 200. For example, the event information module 215 may retrieve the event information from received EPG (electronic program guide) data. The retrieved information may include information such as event title, event summary, event duration, event start/end time, genre, cast, and/or other information.

At 415, a first window comprising information associated with a first subset of the plurality of events may be generated. The first window comprising information associated with the first subset of the plurality of events may be generated, for example, by the CPE device 200 (e.g., by an event window module 220 of FIG. 2). In embodiments, the event window module 220 may identify a first subset of the plurality of events. For example, the first subset of the plurality of events may include a program currently being presented to a viewer through the CPE device 200 and/or a following event (i.e., a program that is scheduled to begin following the end of the program currently being presented to a viewer through the CPE device 200). The event window module 220 may place retrieved information associated with the first subset of the plurality of events in the first window. The event window module 220 may place a user-selectable navigation icon in the first window. For example, the user-selectable navigation icon may be an icon that provides a directional indicator (e.g., an arrow). The directional indicator may indicate a selection of a next subset of events.

At 420, a display of the first window may be output. For example, the display of the first window may be output from the CPE device 200 to a display associated with the CPE device 200 (e.g., a display or display device connected to or otherwise associated with the CPE device 200).

At 425, a trigger for displaying a second subset of the plurality of events may be detected. The trigger for displaying the second subset of the plurality of events may be detected, for example, by the CPE device 200. In embodiments, the trigger for displaying the second subset of the plurality of events may be a communication or signal that is received by the CPE device 200 and is designated by the CPE device 200 as a trigger for displaying a next subset of events. For example, the trigger for displaying the second subset of the plurality of events may be a communication or signal received by the CPE device 200 in response to a user selection of the user-selectable navigation icon displayed in the first window.

At 430, a second window comprising information associated with a second subset of the plurality of events may be generated. The second window comprising information associated with the second subset of the plurality of events may be generated, for example, by the CPE device 200 (e.g., by an event window module 220 of FIG. 2). In embodiments, the event window module 220 may identify a second subset of the plurality of events. For example, the second subset of the plurality of events may include one or more events that are scheduled to follow the subset of events currently displayed in the first window (i.e., one or more programs that are scheduled to begin following the end of the one or more programs currently identified in the first window). The event window module 220 may place retrieved information associated with the second subset of the plurality of events in the second window. The event window module 220 may place one or more user-selectable navigation icons in the second window. For example, the one or more user-selectable navigation icons may include an icon that provides a next directional indicator (e.g., an arrow) indicating a selection of a next subset of events and/or an icon that provides a previous directional indicator (e.g., an arrow) indicating a selection of a previous subset of events.

At 435, a display of the second window may be output. For example, the display of the second window may be output from the CPE device 200 to a display associated with the CPE device 200 (e.g., a display or display device connected to or otherwise associated with the CPE device 200).

At 440, a trigger for displaying a third subset of the plurality of events may be detected. The trigger for displaying the third subset of the plurality of events may be detected, for example, by the CPE device 200. In embodiments, the trigger for displaying the third subset of the plurality of events may be a communication or signal that is received by the CPE device 200 and is designated by the CPE device 200 as a trigger for displaying either a next subset of events or a previous subset of events. For example, the trigger for displaying the third subset of the plurality of events may be a communication or signal received by the CPE device 200 in response to a user selection of a user-selectable navigation icon that is displayed in the second window, and the selection of the user-selectable navigation icon may include a directional component. The selected user-selectable navigation icon may include a next directional component or a previous directional component.

At 445, one or more events making up the third subset of the plurality of events may be identified. The one or more events making up the third subset of the plurality of events may be identified, for example, by the CPE device 200 (e.g., by the event window module 220). In embodiments, the one or more events making up the third subset of the plurality of events may be identified based upon the directional component associated with the trigger for displaying the third subset of the plurality of events (i.e., the trigger identified at 440). Where the trigger for displaying the third subset of the plurality of events is a selection of a user-selectable navigation icon having a next directional component, the CPE device 200 may identify one or more events that are scheduled to follow the subset of events currently displayed in the second window (i.e., one or more programs that are scheduled to begin following the end of the one or more programs currently identified in the second window) as the event(s) making up the third subset of the plurality of events. Where the trigger for displaying the third subset of the plurality of events is a selection of a user-selectable navigation icon having a previous directional component, the CPE device 200 may identify one or more events occurring or scheduled to occur before the one or more events included in the second subset of the plurality of events (i.e., the one or more events making up the first subset of events) as the event(s) making up the third subset of the plurality of events.

At 450, a third window comprising information associated with the third subset of the plurality of events may be generated. The third window comprising information associated with the third subset of the plurality of events may be generated, for example, by the CPE device 200 (e.g., by an event window module 220 of FIG. 2). In embodiments, the event window module 220 may place retrieved information associated with the third subset of the plurality of events (i.e., the event(s) identified at 445) in the third window. The event window module 220 may place one or more user-selectable navigation icons in the third window. For example, the one or more user-selectable navigation icons may include an icon that provides a next directional indicator (e.g., an arrow) indicating a selection of a next subset of events and/or an icon that provides a previous directional indicator (e.g., an arrow) indicating a selection of a previous subset of events.

At 455, a display of the third window may be output. For example, the display of the third window may be output from the CPE device 200 to a display associated with the CPE device 200 (e.g., a display or display device connected to or otherwise associated with the CPE device 200).

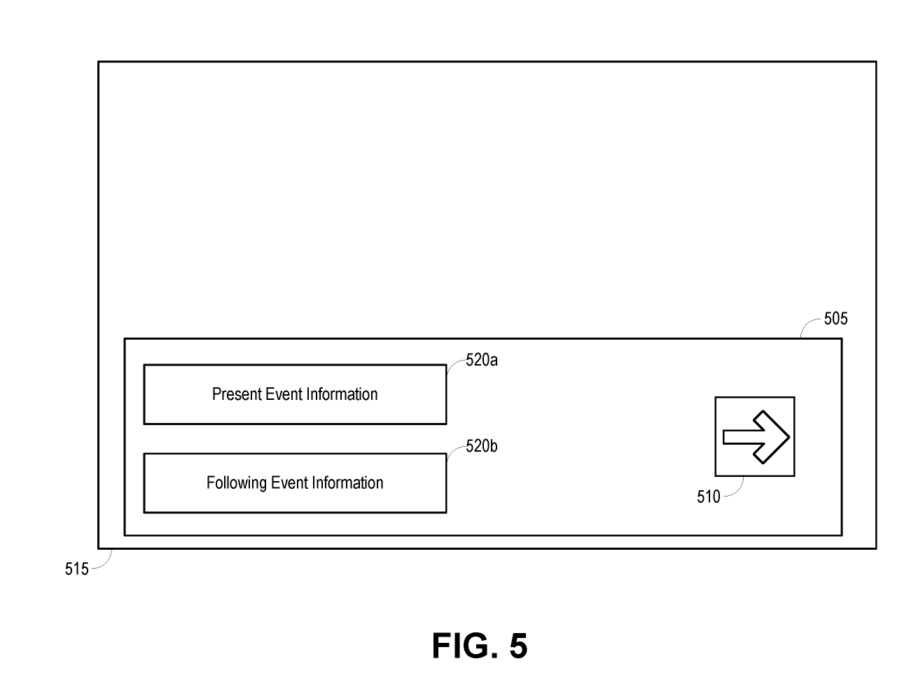

FIG. 5 is an illustration of an example event information window 505 having a user-selectable navigation icon 510 with a next directional component. In embodiments, the event information window 505 may be positioned along an edge (e.g., the bottom edge, top edge, side edge, etc.) of a display window 515. The event information window 505 may be presented as overlaying a portion of content that may be presented within the display window 515.

In embodiments, the event information window 505 may include one or more event information blocks 520a-b. For example, each of the one or more event information blocks 520a-b may include information (e.g., event title, event summary, event duration, event start/end time, genre, cast, and other information) associated with a corresponding event that is identified as an event making up a subset of events being presented in the event information window 505. As an example, the event information window 505 may include an event information block 520a (“Present Event Information”) displaying information associated with a program currently being presented to a viewer and an event information block 520b (“Following Event Information”) displaying information associated with a program that is scheduled to begin following the end of the current event.

In embodiments, the event information window 505 may include a user-selectable navigation icon 510 having a next directional component. For example, the user-selectable navigation icon 510 may be an icon that provides a directional indicator (e.g., an arrow) that indicates a selection of a next subset of events. The user-selectable navigation icon 510 may be selected by a viewer (e.g., by highlighting the navigation icon with a cursor, by depressing a designated button at an interface or remote control unit, or by otherwise communicating a selection of the navigation icon), and in response, a next subset of events may be identified and presented in a refreshed event information window.

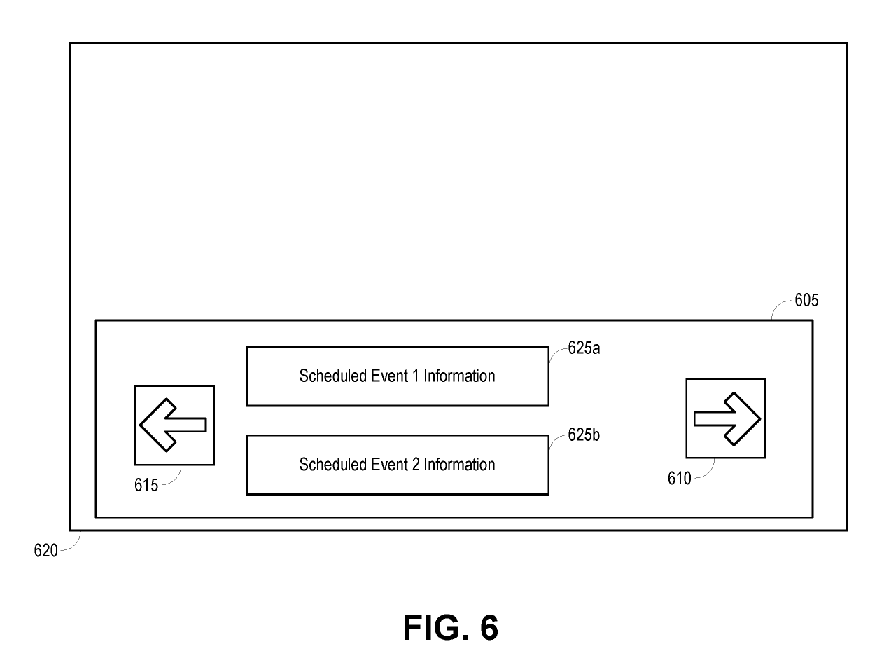

FIG. 6 is an illustration of an example event information window 605 having a user-selectable navigation icon 610 with a next directional component and a user-selectable navigation icon 615 with a previous directional component. In embodiments, the event information window 605 may be positioned along an edge (e.g., the bottom edge, top edge, side edge, etc.) of a display window 620. The event information window 605 may be presented as overlaying a portion of content that may be presented within the display window 620.

In embodiments, the event information window 605 may include one or more event information blocks 625a-b. For example, each of the one or more event information blocks 625a-b may include information (e.g., event title, event summary, event duration, event start/end time, genre, cast, and other information) associated with a corresponding event that is identified as an event making up a subset of events being presented in the event information window 605. As an example, the event information window 605 may include an event information block 625a (“Scheduled Event 1 Information”) displaying information associated with a first program that is scheduled to begin following one or more programs that are associated with a subset of events presented in a previous event information window (i.e., events associated with event information blocks 520a-b of FIG. 5) and an event information block 625b (“Scheduled Event 2 Information”) displaying information associated with a second program that is scheduled to begin following the event associated with the event information block 625a.

In embodiments, the event information window 605 may include a user-selectable navigation icon 610 having a next directional component. For example, the user-selectable navigation icon 610 may be an icon that provides a directional indicator (e.g., an arrow) that indicates a selection of a next subset of events. The user-selectable navigation icon 610 may be selected by a viewer (e.g., by highlighting the navigation icon with a cursor, by depressing a designated button at an interface or remote control unit, or by otherwise communicating a selection of the navigation icon), and in response, a next subset of events may be identified and presented in a refreshed event information window.

In embodiments, the event information window 605 may include a user-selectable navigation icon 615 having a previous directional component. For example, the user-selectable navigation icon 615 may be an icon that provides a directional indicator (e.g., an arrow) that indicates a selection of a previous subset of events. The user-selectable navigation icon 615 may be selected by a viewer (e.g., by highlighting the navigation icon with a cursor, by depressing a designated button at an interface or remote control unit, or by otherwise communicating a selection of the navigation icon), and in response, a previous subset of events may be identified and presented in a refreshed event information window.

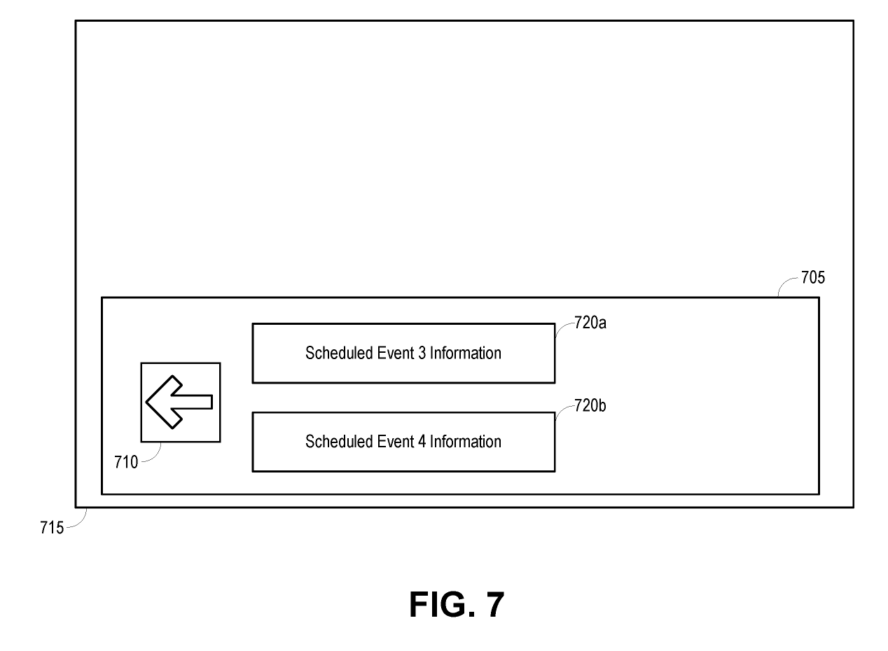

FIG. 7 is an illustration of an example event information window 705 having a user-selectable navigation icon 710 with a previous directional component. In embodiments, the event information window 705 may be positioned along an edge (e.g., the bottom edge, top edge, side edge, etc.) of a display window 715. The event information window 705 may be presented as overlaying a portion of content that may be presented within the display window 715.

In embodiments, the event information window 705 may include one or more event information blocks 720a-b. For example, each of the one or more event information blocks 720a-b may include information (e.g., event title, event summary, event duration, event start/end time, genre, cast, and other information) associated with a corresponding event that is identified as an event making up a subset of events being presented in the event information window 705. As an example, the event information window 705 may include an event information block 720a (“Scheduled Event 3 Information”) displaying information associated with a program that is scheduled to begin following one or more programs that are associated with a subset of events presented in a previous event information window (i.e., events associated with event information blocks 625a-b of FIG. 6) and an event information block 720b (“Scheduled Event 4 Information”) displaying information associated with a program that is scheduled to begin following the event associated with the event information block 720a.

In embodiments, the event information window 705 may include a user-selectable navigation icon 710 having a previous directional component. For example, the user-selectable navigation icon 710 may be an icon that provides a directional indicator (e.g., an arrow) that indicates a selection of a previous subset of events. The user-selectable navigation icon 710 may be selected by a viewer (e.g., by highlighting the navigation icon with a cursor, by depressing a designated button at an interface or remote control unit, or by otherwise communicating a selection of the navigation icon), and in response, a previous subset of events may be identified and presented in a refreshed event information window.

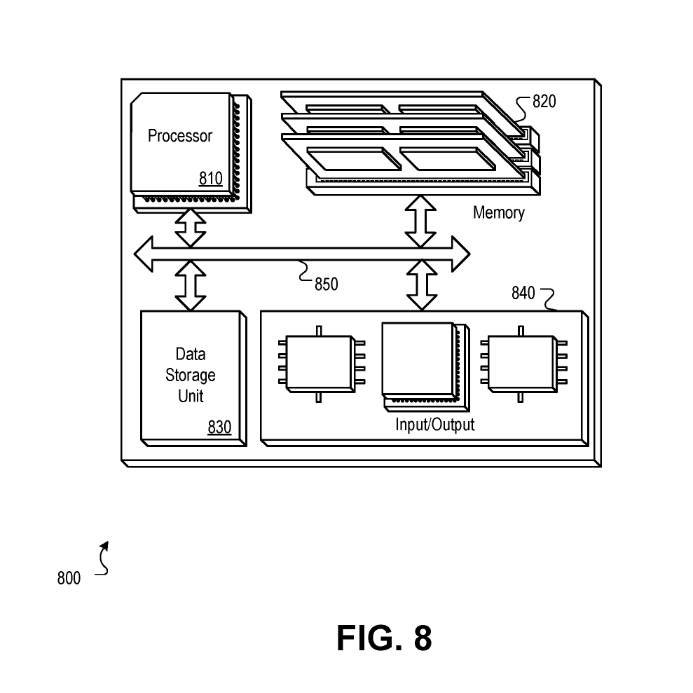

FIG. 8 is a block diagram of a hardware configuration 800 operable to facilitate the generation and presentation of a window displaying navigable program information. The hardware configuration 800 can include a processor 810, a memory 820, a storage device 830, and an input/output device 840. Each of the components 810, 820, 830, and 840 can, for example, be interconnected using a system bus 850. The processor 810 can be capable of processing instructions for execution within the hardware configuration 800. In one implementation, the processor 810 can be a single-threaded processor. In another implementation, the processor 810 can be a multi-threaded processor. The processor 810 can be capable of processing instructions stored in the memory 820 or on the storage device 830.

The memory 820 can store information within the hardware configuration 800. In one implementation, the memory 820 can be a computer-readable medium. In one implementation, the memory 820 can be a volatile memory unit. In another implementation, the memory 820 can be a non-volatile memory unit.

In some implementations, the storage device 830 can be capable of providing mass storage for the hardware configuration 800. In one implementation, the storage device 830 can be a computer-readable medium. In various different implementations, the storage device 830 can, for example, include a hard disk device, an optical disk device, flash memory or some other large capacity storage device. In other implementations, the storage device 830 can be a device external to the hardware configuration 800.

The input/output device 840 provides input/output operations for the hardware configuration 800. In one implementation, the input/output device 840 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a client device 105 of FIG. 1 (e.g., television, STB, computer, mobile device, tablet, etc.), an access device 110 of FIG. 1 (e.g., gateway device, wireless router, network extender, etc.), or STB 115 of FIG. 1. In embodiments, the input/output device can include driver devices configured to send communications to, and receive communications from one or more networks (e.g., WAN 120 of FIG. 1, provider network 125 of FIG. 1, local network, etc.).

Those skilled in the art will appreciate that the invention improves upon methods and systems for providing event information to a user. Methods, systems and computer readable media described herein may facilitate the generation and presentation of a window displaying navigable program information. Information associated with a plurality of events may be retrieved, and retrieved information associated with a subset of the events may be presented within a displayed window. The displayed window may include one or more user-selectable navigation icons, each navigation icon having a directional component. When a navigation icon is selected, one or more events making up a different subset of events may be identified based upon the directional component associated with the selected navigation icon, and the displayed window may be refreshed to include information associated with the different subset of events.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
detecting a trigger for displaying an event window;
retrieving information associated with a plurality of events;
generating a first window comprising information associated with a first subset of the plurality of events, wherein the first window comprises at least one navigation icon;
outputting a display of the first window;
detecting a trigger for displaying information associated with a second subset of the plurality of events;
generating a second window comprising information associated with the second subset of the plurality of events, wherein the second window comprises at least one navigation icon; and
outputting a display of the second window.

2. The method of claim 1, wherein the trigger for displaying the event window comprises a tuning of a customer premise equipment device to a channel.

3. The method of claim 2, wherein the plurality of events comprises a plurality of programs that are scheduled for playback on the channel.

4. The method of claim 1, wherein the first subset of the plurality of events comprises a program that is currently being presented and a program that is scheduled to begin following the end of the program that is currently being presented.

5. The method of claim 1, wherein the second subset of the plurality of events comprises one or more programs that are scheduled to begin following the end of the first subset of the plurality of events.

6. The method of claim 1, further comprising:
detecting a trigger for displaying information associated with a third subset of the plurality of events, wherein the trigger for displaying the third subset of the plurality of events comprises an indication of a directional component;
based upon the directional component and the one or more events making up the second subset of the plurality of events, identifying one or more events making up the third subset of the plurality of events;
generating a third window comprising information associated with the third subset of the plurality of events, wherein the third window comprises at least one navigation icon; and
outputting a display of the third window.

7. The method of claim 1, wherein the display of the first window and the display of the second window overlay a portion of content that is presented within a display screen.

8. An apparatus comprising one or more modules that:
detect a trigger for displaying an event window;
retrieve information associated with a plurality of events;
generate a first window comprising information associated with a first subset of the plurality of events, wherein the first window comprises at least one navigation icon;
output a display of the first window;
detect a trigger for displaying information associated with a second subset of the plurality of events;
generate a second window comprising information associated with the second subset of the plurality of events, wherein the second window comprises at least one navigation icon; and
output a display of the second window.

9. The apparatus of claim 8, wherein the trigger for displaying the event window comprises a tuning of a customer premise equipment device to a channel.

10. The apparatus of claim 9, wherein the plurality of events comprises a plurality of programs that are scheduled for playback on the channel.

11. The apparatus of claim 8, wherein the first subset of the plurality of events comprises a program that is currently being presented and a program that is scheduled to begin following the end of the program that is currently being presented.

12. The apparatus of claim 8, wherein the second subset of the plurality of events comprises one or more programs that are scheduled to begin following the end of the first subset of the plurality of events.

13. The apparatus of claim 8, wherein the one or more modules:
detect a trigger for displaying information associated with a third subset of the plurality of events, wherein the trigger for displaying the third subset of the plurality of events comprises an indication of a directional component;
based upon the directional component and the one or more events making up the second subset of the plurality of events, identify one or more events making up the third subset of the plurality of events;
generate a third window comprising information associated with the third subset of the plurality of events, wherein the third window comprises at least one navigation icon; and
output a display of the third window.

14. One or more non-transitory computer readable media having instructions operable to cause one or more processors to perform the operations comprising:
detecting a trigger for displaying an event window;
retrieving information associated with a plurality of events;
generating a first window comprising information associated with a first subset of the plurality of events, wherein the first window comprises at least one navigation icon;
outputting a display of the first window;
detecting a trigger for displaying information associated with a second subset of the plurality of events;
generating a second window comprising information associated with the second subset of the plurality of events, wherein the second window comprises at least one navigation icon; and
outputting a display of the second window.

15. The one or more non-transitory computer-readable media of claim 14, wherein the trigger for displaying the event window comprises a tuning of a customer premise equipment device to a channel.

16. The one or more non-transitory computer-readable media of claim 15, wherein the plurality of events comprises a plurality of programs that are scheduled for playback on the channel.

17. The one or more non-transitory computer-readable media of claim 14, wherein the first subset of the plurality of events comprises a program that is currently being presented and a program that is scheduled to begin following the end of the program that is currently being presented.

18. The one or more non-transitory computer-readable media of claim 14, wherein the second subset of the plurality of events comprises one or more programs that are scheduled to begin following the end of the first subset of the plurality of events.

19. The one or more non-transitory computer-readable media of claim 14, wherein the instructions are further operable to cause the one or more processors to perform the operations comprising:
detecting a trigger for displaying information associated with a third subset of the plurality of events, wherein the trigger for displaying the third subset of the plurality of events comprises an indication of a directional component;
based upon the directional component and the one or more events making up the second subset of the plurality of events, identifying one or more events making up the third subset of the plurality of events;
generating a third window comprising information associated with the third subset of the plurality of events, wherein the third window comprises at least one navigation icon; and
outputting a display of the third window.

20. The one or more non-transitory computer-readable media of claim 14, wherein the display of the first window and the display of the second window overlay a portion of content that is presented within a display screen.
